(19) United States
(12) Patent Application Publication
(10) Pub. No.: US 2008/0022724 A1
(43) Pub. Date: Jan. 31, 2008

(54) MOLDING DIE FOR MOLDING GLASS AND REPRODUCING METHOD THEREOF

(76) Inventors: Yung-I CHEN, Taipei City (TW); Raymond Chin-Chung, Taipei City (TW)

Correspondence Address: SINORICA, LLC, 528 FALLSGROVE DRIVE, ROCKVILLE, MD, 20850, US

(21) Appl. No.: 11/740,950

(22) Filed: Apr. 27, 2007

(30) Foreign Application Priority Data
Jul. 31, 2006 (TW) 95128024

(51) Int. Cl. B29C 51/14

(52) U.S. Cl. 65/374.12; 427/307

(57) ABSTRACT

A molding die for molding glass includes a base material, a first intermediate layer on the base material, and a protective film on the first intermediate layer. The first intermediate layer is made of titanium or other materials that is not easy to be attacked, and the protective film is made of molybdenum alloy. A method of reproducing the molding die of the present invention includes removing the protective film but keeping the first intermediate layer and the base material still, and then coating a new protective layer on the first intermediate layer.

### BACKGROUND OF THE INVENTION

1. Field of the Invention

The present invention relates generally to a molding die for molding glass, and more particularly to a molding die for molding glass and a reproducing method thereof.

2. Description of the Related Art

Conventional molding dies for molding glass includes two types, one of which includes a base material and a protective film on the surface of the base material, and the other of which further includes a buffer layer between the base material and the protective film to enhance the adhesion of the protective film. The base material may be made of stainless, silicon carbide, or tungsten carbide, or the like. The protective film may be made of amorphous carbon or hard ceramics, such as silicon carbide and silicon nitride, or precious metal film. The precious metal film includes platinum-iridium (Pt—Ir) alloy series and precious metal alloy of iridium (Ir) or ruthenium (Ru).

After a time of use, the protective film of the molding die will be damaged. The protective film made of precious metal has a high cost and is higher in fixing the damaged protective film.

There are some reproducing techniques in the prior art. One conventional technique utilizes plasma etching to oxidize the protective film of carbon thin film for reproduction. The other technique uses the character of precious metal, which is less corroded, and provides the precious metal or alloy thereof to be an intermediate, so that the intermediate will not be damaged when the damaged protective film is removed by acid or alkali, and then a new protective film is coated on the intermediate. This technique needs precious metal and alloy thereof that the cost of reproduction is higher too.

### SUMMARY OF THE INVENTION

The primary objective of the present invention is to provide a molding die for molding glass and a reproducing method thereof, which has lower manufacture cost, simple process and high precision for molding glass lenses.

According to the objective of the present invention, a molding die for molding glass includes a base material, a first intermediate layer on the base material, and a protective film on the first intermediate layer. The first intermediate layer is made of titanium or other materials that is not easy to be attacked, and the protective film is made of molybdenum alloy. A method of reproducing the molding die of the present invention includes removing the protective film but keeping the first intermediate layer and the base material still, and then coating a new protective layer on the first intermediate layer.

### BRIEF DESCRIPTION OF THE DRAWINGS

FIG. 1 is a perspective view of a first preferred embodiment of the present invention;

FIG. 2 is a perspective view of a second preferred embodiment of the present invention; and

FIG. 3 is a flow chart of the reproducing method of the present invention.

### DETAILED DESCRIPTION OF THE INVENTION

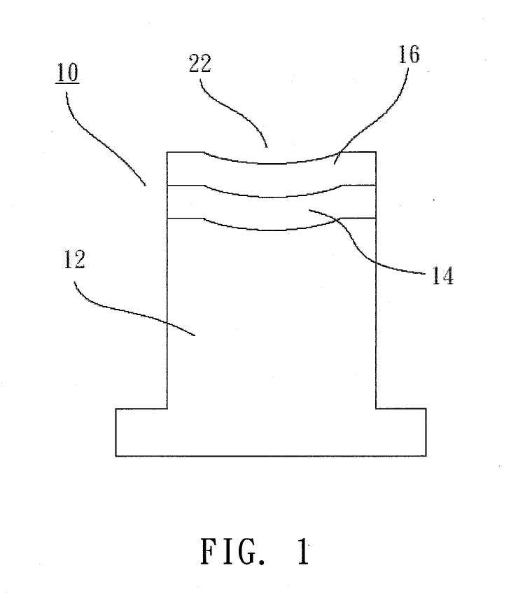

As shown in FIG. 1, a molding die 10 for molding glass of the first preferred embodiment of the present invention mainly includes a base material 12 made of wolfram carbide alloy, a first intermediate layer 14, which is made of titanium, tantalum, titanium alloy, or tantalum alloy with a thickness of 0.1 micrometer to 0.25 micrometer, coated on the base material 12 by sputtering, and a protective film 16 with a thickness of 0.1 micrometer to 1.0 micrometer coated on the first intermediate layer 14. The protective film 16 is made of molybdenum and ruthenium alloy, and molybdenum takes 35% to 70%. The protective film 16 has a molding surface 22, which is a slot, to mold glass. The first intermediate layer 14 may enhance the adhesion of protective film 16 and the base material 12 to prolong the life of the molding die 10.

Table 1 shows different metals coated on the wolfram carbide base material attacked by cerium ammonium nitrite solution. In Table 1, [Ce] is (NH₄)₂Ce(NO₃)₆, HNO₃ is nitric acid, and HAc is acetic acid solution.

The result shows that the protective films made of Mo, Re, Ni and Cr will be attacked by (NH₄)₂Ce(NO₃)₆ solution, and the wolfram carbide base material under the protective film will be attacked as well. Ru has stronger resistance to the solution. 0.2 micrometer Ru will be totally attacked in 30 minutes. Ti and Ta have the strongest resistance that they are not attacked over 30 minutes. Therefore, we choose Ti and Ta to be the first intermediate layer 14 to protect the wolfram carbide base material 12.

Table 2 shows the attack condition of the molding die, in which Mo—Ru protective film with Cr or Ni intermediate layer will be attacked and the wolfram carbide base material will be attacked as well, and the attack action will not stop. The reason of this result is that Mo—Ru alloy protective film, which structure includes Ru, Mo₅Ru₃ and Mo phases. As described above, Ru has stronger resistance than Mo, Cr, and Ni, so that the attack path goes through the Mo contained phase to attack the first intermediate layer. Because the first intermediate layer be easily attacked, so that the wolfram carbide base material will be badly damaged by the solution before the protective film 16 is out. In the results of No. 25 to No. 27, they show Ti first intermediate layer may isolate the solution from the wolfram carbide base material and maintain smooth surface.

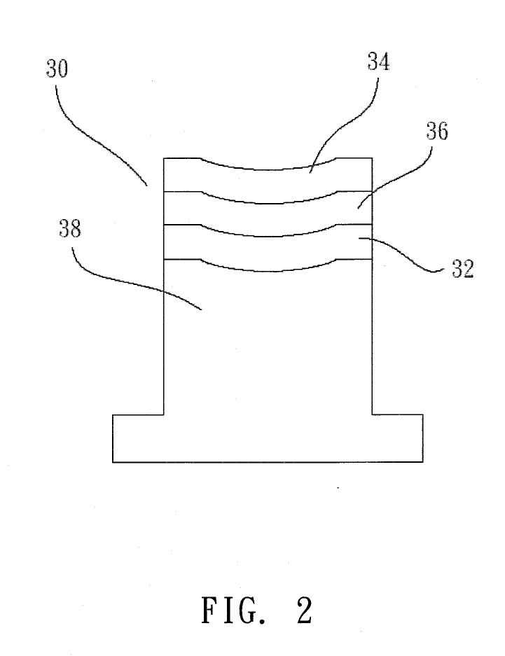

As shown in FIG. 2, a molding die 30 of the second preferred embodiment of the present invention, which is similar to the molding die 10 of the first embodiment, except that there is a second intermediate layer 36 between a first intermediate layer 32 and a protective film 34. The second intermediate layer 36, which thickness is about 0.1 micrometer to 0.2 micrometer, is made of chromium, molybdenum, rhenium, nickel or alloy with at least one of above that the second intermediate layer 36 will be easy to be attacked.

Table 3 shows the attack condition of the molding die with two intermediate layers.

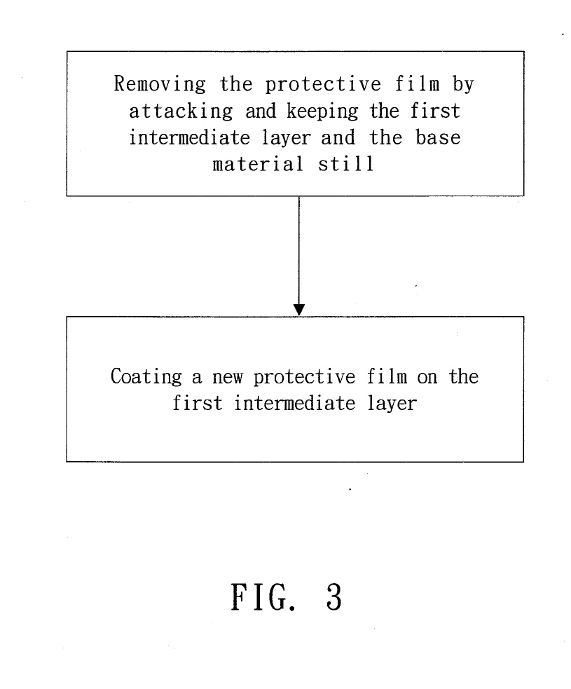

As shown in FIG. 3, a method of reproducing the molding die 10 of the first embodiment of the present invention includes removing the protective film 16 of the molding die 10 but keeping the first intermediate layer 14 and the base material 12 still, and then coating a new protective film 16 on the first intermediate layer 14 by sputtering to reproduce the molding die 10 of the first embodiment.

To reproduce the molding die 30 of the second embodiment of the present invention, it includes removing the protective film 34 and the second intermediate layer 36 but keeping the first intermediate layer 32 and the base material 38 still, and then coating a new protective film 34 and the second intermediate layer 36 by sputtering to reproduce the molding die 30 of the second embodiment.

In conclusion, the present invention has advantages of lower manufacture cost and high precision for molding glass lenses that fits the requirements of mass production and competition.

The description above is a few preferred embodiments of the present invention and the equivalence of the present invention is still in the scope of the claim of the present invention.

TABLE 1

| | Protective | | | | | Result | | | |
|---|---|---|---|---|---|---|---|---|---|
| | film | | Attacking solution | | | | | Attacking | Attacking |
| | | Thickness | (%)* | | | | | protective | base |
| | Constituents | μm | [Ce] | HNO₃ | HAc | Time | | film | material |
| No. 1 | Mo | 0.24 | 6 | 6 | | 2 | min. | yes | yes |
| No. 2 | Mo | 0.24 | 6 | | 8 | 3 | min. | yes | yes |
| No. 3 | Re | 0.16 | 6 | 6 | | 2 | min. | yes | yes |
| No. 4 | Re | 0.18 | 6 | | 8 | 4 | min. | yes | yes |
| No. 5 | Ni | 0.29 | 9 | 2 | | 15 | min. | yes | yes |
| No. 6 | Ni | 0.28 | 12 | 6 | | 5 | min. | yes | yes |
| No. 7 | Cr | 0.19 | 9 | | 4 | 20 | min. | yes | yes |
| No. 8 | Ru | 0.21 | 6 | 6 | | 20/30 | min. | no/yes | no/yes |
| No. 9 | Ru | 0.20 | 6 | 2 | | 20/30 | min. | no/yes | no/yes |
| No. 10 | Ru | 0.20 | 6 | | 8 | 30 | min. | no | no |
| No. 11 | Ti | 0.12 | 12 | 6 | | 30 | min. | no | no |
| No. 12 | Ti | 0.13 | 12 | | 8 | 30 | min. | no | no |
| No. 13 | Ta | 0.23 | 12 | 6 | | 30 | min. | no | no |
| No. 14 | Ta | 0.23 | 12 | | 8 | 30 | min. | no | no |

TABLE 2

| | | | Second | | First | | Attacking | | |
|---|---|---|---|---|---|---|---|---|---|
| | Protective | | intermediate | | intermediate | | solution (%) | | |
| | film | | layer | | layer | | Cerium | | |
| | | Thickness | | Thickness | | Thickness | ammonium | Nitric | Acetic |
| | Constituents | μm | Constituents | μm | Constituents | μm | nitrite | acid | acid |
| No. 31 | Mo—Ru | 0.18 | Cr | 0.1 | Ti | 0.1 | 12 | | 8 |
| No. 32 | Mo—Ru | 0.19 | Cr | 0.1 | Ti | 0.1 | 6 | 6 | |
| No. 33 | Mo—Ru | 0.20 | Cr | 0.1 | Ti | 0.1 | 12 | 6 | |
| No. 34 | Mo—Re | 0.50 | Cr | 0.1 | Ti | 0.1 | 12 | | 8 |
| No. 35 | Mo—Re | 0.50 | Cr | 0.1 | Ti | 0.1 | 12 | 6 | |
| No. 36 | Mo—Ru | 0.79 | Cr | 0.12 | Ta | 0.23 | 12 | 6 | |
| No. 37 | Mo—Ru | 0.81 | Cr | 0.12 | Ta | 0.23 | 12 | | 8 |

| | Result | | | | | | |
|---|---|---|---|---|---|---|---|
| | | | | | Attacking | Attacking | |
| | | Roughness | Roughness | Attacking | second | first | Attacking |
| | Time | before | after | protective | intermediate | intermediate | base |
| | Min. | test Å | test Å | film | layer | layer | material |
| No. 31 | 7 | 21 | 27 | yes | yes | no | no |
| No. 32 | 5 | 27 | 25 | yes | yes | no | no |
| No. 33 | 2 | 25 | 23 | yes | yes | no | no |
| No. 34 | 7 | 29 | 25 | yes | yes | no | no |
| No. 35 | 6 | 29 | 33 | yes | yes | no | no |
| No. 36 | 8 | 22 | 26 | yes | yes | no | no |
| No. 37 | 15 | 22 | 23 | yes | yes | no | no |

TABLE 3

| | | | Second | | First | | Attacking | | |
|---|---|---|---|---|---|---|---|---|---|
| | Protective | | intermediate | | intermediate | | solution (%) | | |
| | film | | layer | | layer | | Cerium | | |
| | | Thickness | | Thickness | | Thickness | ammonium | Nitric | Acetic |
| | Constituents | μm | Constituents | μm | Constituents | μm | nitrite | acid | acid |
| No. 31 | Mo—Ru | 0.18 | Cr | 0.1 | Ti | 0.1 | 12 | | 8 |
| No. 32 | Mo—Ru | 0.19 | Cr | 0.1 | Ti | 0.1 | 6 | 6 | |
| No. 33 | Mo—Ru | 0.20 | Cr | 0.1 | Ti | 0.1 | 12 | 6 | |
| No. 34 | Mo—Re | 0.50 | Cr | 0.1 | Ti | 0.1 | 12 | | 8 |
| No. 35 | Mo—Re | 0.50 | Cr | 0.1 | Ti | 0.1 | 12 | 6 | |
| No. 36 | Mo—Ru | 0.79 | Cr | 0.12 | Ta | 0.23 | 12 | 6 | |
| No. 37 | Mo—Ru | 0.81 | Cr | 0.12 | Ta | 0.23 | 12 | | 8 |

| | Result | | | | | | |
|---|---|---|---|---|---|---|---|
| | | | | | Attacking | Attacking | |
| | | Roughness | Roughness | Attacking | second | first | Attacking |
| | Time | before | after | protective | intermediate | intermediate | base |
| | Min. | test Å | test Å | film | layer | layer | material |
| No. 31 | 7 | 21 | 27 | yes | yes | no | no |
| No. 32 | 5 | 27 | 25 | yes | yes | no | no |
| No. 33 | 2 | 25 | 23 | yes | yes | no | no |
| No. 34 | 7 | 29 | 25 | yes | yes | no | no |
| No. 35 | 6 | 29 | 33 | yes | yes | no | no |
| No. 36 | 8 | 22 | 26 | yes | yes | no | no |
| No. 37 | 15 | 22 | 23 | yes | yes | no | no |

What is claimed is:

1. A molding die for molding glass, comprising:
a base material;
a first intermediate layer, which is made of titanium or other materials that is not easy to be attacked, on the base material; and
a protective film, which is made of molybdenum alloy, on the first intermediate layer.

2. The molding die as defined in claim 1, wherein the base material is made of wolfram carbide alloy.

3. The molding die as defined in claim 1, wherein a thickness of the first intermediate layer is in a range between 0.1 micrometer and 0.25 micrometer.

4. The molding die as defined in claim 1, wherein the protective film further includes ruthenium, or rhenium or both.

5. The molding die as defined in claim 4, wherein there are 35% to 70% molybdenum in the protective film.

6. The molding die as defined in claim 1, wherein a thickness of the protective film is in a range between 0.1 micrometer and 1.0 micrometer.

7. The molding die as defined in claim 1, wherein the first intermediate layer is made of titanium, tantalum, titanium alloy or tantalum alloy.

8. The molding die as defined in claim 1, further comprising a second intermediate layer, which is made of chromium or other material that is easy to be attacked, between first intermediate layer and the protective layer.

9. The molding die as defined in claim 8, wherein the second intermediate layer includes chromium, molybdenum, rhenium, nickel or an alloy with at least one of above.

10. The molding die as defined in claim 8, wherein a thickness of the second intermediate layer is in a range between 0.1 micrometer and 0.2 micrometer.

11. A method of reproducing the molding die as defined in claim 1, comprising the steps of attacking the protective film to remove the protective film but keep the first intermediate layer and the base material still, and then coating a new protective layer on the first intermediate layer.

12. The method as defined in claim 11, wherein an attacking solution is utilized in removing the protective film.

13. The method as defined in claim 12, wherein the attacking solution includes (NH₄)₂Ce(NO₃)₆.

14. The method as defined in claim 13, wherein the attacking solution is acetic acid or nitric acid.

15. A method of reproducing the molding die as defined in claim 8, comprising the steps of attacking the protective film and the second intermediate layer to remove the protective film and the second intermediate layer but keep the first intermediate layer and the base material still, and then coating a new second intermediate layer on the first intermediate layer and a new protective layer on the second intermediate layer.

16. The method as defined in claim 15, wherein an attacking solution is utilized in removing the protective film.

17. The method as defined in claim 16, wherein the attacking solution includes (NH₄)₂Ce(NO₃)₆.

18. The method as defined in claim 17, wherein the attacking solution is acetic acid or nitric acid.
